(19) United States
(12) Patent Application Publication
(10) Pub. No.: US 2023/0399805 A1
(43) Pub. Date: Dec. 14, 2023

(54) SYSTEMS, DEVICES, AND METHODS FOR CORAL REEF CONSTRUCTION

(71) Applicants: David Alexander James Washbrook, Dubai (AE); James Patrick Usher, Dubai (AE)

(72) Inventors: David Alexander James Washbrook, Dubai (AE); James Patrick Usher, Dubai (AE)

(21) Appl. No.: 18/329,192

(22) Filed: Jun. 5, 2023

Related U.S. Application Data
(60) Provisional application No. 63/350,111, filed on Jun. 8, 2022.

(51) Int. Cl. E02B 3/04

(52) U.S. Cl. CPC E02B 3/046

(57) ABSTRACT

Systems, devices, and methods capable of constructing and growing new coral reefs. Such a system includes at least a first growth line having first couplers attached thereto, support frames supporting the first growth line above a seabed, and growth plates releasably coupled to the first growth line and supported thereby above the seabed. Each of the growth plates has first and second surfaces, a second coupler at the first surface thereof that is configured for releasably coupling to one of the first couplers of the first growth line, and a third coupler at the second surface thereof. The second surfaces of the growth plates are operable for growing coral thereon. The system further includes bases each having an anchor configured for securing the base to the seabed and having a fourth coupler configured for releasably coupling to the second couplers of the growth plates.

### CROSS-REFERENCE TO RELATED APPLICATIONS

This application claims the benefit of U.S. Provisional Application No. 63/350,111 filed Jun. 8, 2022, the contents of which are incorporated herein by reference.

### BACKGROUND OF THE INVENTION

The invention generally relates to systems, devices, and methods for constructing a coral reef.

Coral reefs are underwater sea ecosystems in which coral grows over a seabed or other underwater substrate surface. Coral reefs typically provide unique ecosystems for many other types of underwater flora and fauna. However, coral in a coral reef may die, for example, due to environmental changes, which if not alleviated can destroy the entire coral reef ecosystem. To mitigate the loss of natural coral reefs, efforts have been made to grow new coral on various natural and artificial growth substrates. However, coral is delicate and highly sensitive to changes in their surrounding environment, which makes it difficult to successfully seed and grow new coral reefs.

In view of the above, it would be desirable if systems, devices, and/or methods were available that were capable of successfully constructing and growing new coral reefs.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, systems, devices, and methods capable of constructing and growing new coral reefs.

According to a nonlimiting aspect of the invention, a system is provided for constructing a coral reef. The system includes at least a first growth line having first couplers attached thereto, support frames supporting the first growth line above a seabed, and growth plates releasably coupled to the first growth line and supported thereby above the seabed. Each of the growth plates has first and second surfaces, a second coupler at the first surface thereof that is configured for releasably coupling to one of the first couplers of the first growth line, and a third coupler at the second surface thereof. The second surfaces of the growth plates are operable for growing coral thereon. The system further includes bases each having an anchor configured for securing the base to the seabed and having a fourth coupler configured for releasably coupling to the second couplers of the growth plates.

According to a nonlimiting aspect of the invention, a method is provided for constructing a coral reef using a system comprising elements as described above. The method includes growing coral on the second surfaces of the growth plates, coupling the second couplers of the growth plates to the first couplers of the first growth line, deploying the first growth line with the growth plates coupled thereto from a vessel to support the first growth line and the growth plates coupled thereto above the seabed within a seabed nursery area, further growing the coral on the growth plates, decoupling the growth plates from the first growth line, and then transferring the growth plates to the bases after the bases have been secured to the seabed with the anchors thereof so as to construct a coral reef.

Technical aspects of systems, devices, and methods having features as described above preferably include the ability to transfer and then grow coral in its future habitat with matching conditions within a nursery area that may encompass a large area of the seabed. Additionally, the coral type can be preselected by genetic selection based on the bathymetry of the seabed to promote the resilience and growth potential.

These and other aspects, arrangements, features, and/or technical effects will be appreciated from the following detailed description.

### BRIEF DESCRIPTION OF THE DRAWINGS

FIG. 1 is a schematic representation of a nursery area of a seabed in which a system and various devices thereof are being deployed for constructing a coral reef according to a nonlimiting embodiment of the invention.

FIG. 2 is a plan view of the nursery area of FIG. 1 following deployment of certain devices of the system on the seabed.

FIG. 3 is a side view of a support frame of the system of FIGS. 1 and 2.

FIG. 4 is a schematic representation of a growth line, growth plates, and a base of the system of FIG. 1, and depicts one of the growth plates being transferred from the growth line to the base secured to the seabed.

FIG. 5A schematically represents a plan view of one of the growth plates of FIGS. 1, 2, and 4, and FIG. 5B schematically represents a plan view of an alternative configuration for a growth plate that can be utilized with the system of FIGS. 1, 2, and 4.

FIG. 6 is a schematic representation of a method of transferring a growth plate from a growth line of the system of FIG. 1 to the seabed using a remote operated vehicle equipped with tooling adapted to manipulate the growth plates.

FIG. 7 is a side elevation view of the tooling of FIG. 6.

FIG. 8 is an end view of the tooling of FIG. 7 depicting the tooling coupled to the growth plate of FIG. 5A.

### DETAILED DESCRIPTION OF THE INVENTION

The intended purpose of the following detailed description of the invention and the phraseology and terminology employed therein is to describe what is shown in the drawings, which include depictions of one or more nonlimiting embodiments of the invention, and to describe certain but not all aspects of what is depicted in the drawings, including the embodiment(s) depicted in the drawings. The following detailed description also identifies certain but not all alternatives of the embodiment(s) depicted in the drawings. As nonlimiting examples, the invention encompasses additional or alternative embodiments in which one or more features or aspects shown and/or described as part of a particular depicted embodiment could be eliminated, and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

The following disclosure describes various aspects of systems, devices, and methods for constructing and growing new coral reefs by transplanting nursery-grown coral to seabed nursery areas where the new coral reefs are desired. In a nonlimiting system described below, the coral is initially grown in a nursery on growth plates, which are later transported to and placed in a seabed nursery area where the coral can continue to grow until eventually being transplanted to the nearby seabed. To facilitate the description provided below of the system represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of the system and its components as represented in the drawings. All such relative terms are useful to describe the illustrated embodiment(s) but should not be otherwise interpreted as limiting the scope of the invention.

According to a nonlimiting approach to utilizing the system, its devices, and methods described below, sources of the nursery-grown coral can be coral spores and/or microfragments of coral that were collected and/or harvested throughout appropriate seasons. Coral types of the nursery-grown coral intended to be transplanted to a particular seabed can be selected by genetic selection based on seabed bathymetry of the seabed for resilience and growth potential. The selected coral spores and/or microfragments are then grown on the growth plates within a controlled environment of a coral nursery, as a nonlimiting example, a manmade facility separate from the seabed nursery area, until the coral reaches a sufficient level of growth maturity that the coral is deemed fit to be able to survive within the environment of the intended seabed nursery area. The growth plates on which the coral has been grown are then transported to a seabed nursery area, for example, on a vessel such as a boat or ship, in vats prepared to maintain acceptable environmental conditions for the coral.

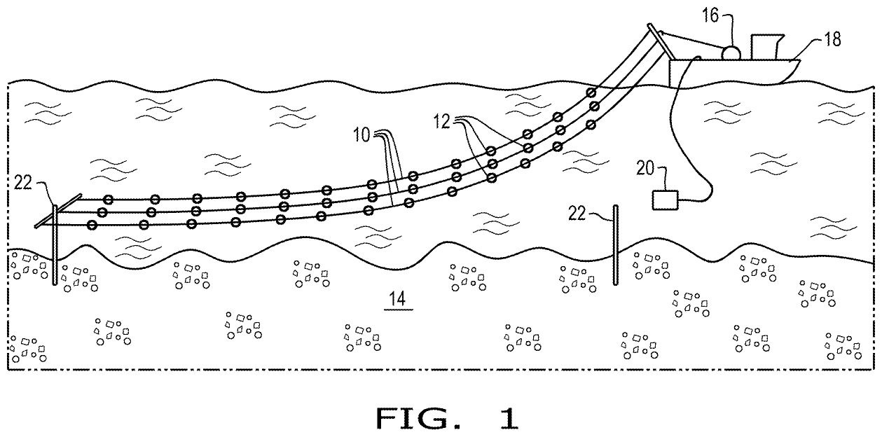

Turning now to the drawings, FIG. 1 schematically represents multiple growth lines 10 in the process of being deployed from a vessel 18, such as a boat or ship, into a seabed nursery area that has been designated within a location of a seabed 14. FIG. 1 further represents growth plates 12 attached to the growth lines 10, so that the growth lines 10 and plates 12 can be simultaneously dispensed from a spool, drum, or reel (hereinafter, reel 16) on the vessel 18, optionally with the assistance of an underwater remote-operated vehicle (ROV) 20. As noted above, the coral to be transplanted to the seabed 14 was grown on the growth plates 12 within a controlled environment of a coral nursery. While transported on the vessel 18, the coral on the growth plates 12 is preferably continually misted with sea water and shaded to prevent sun damage or UV bleaching prior to the growth plates 12 entering the water.

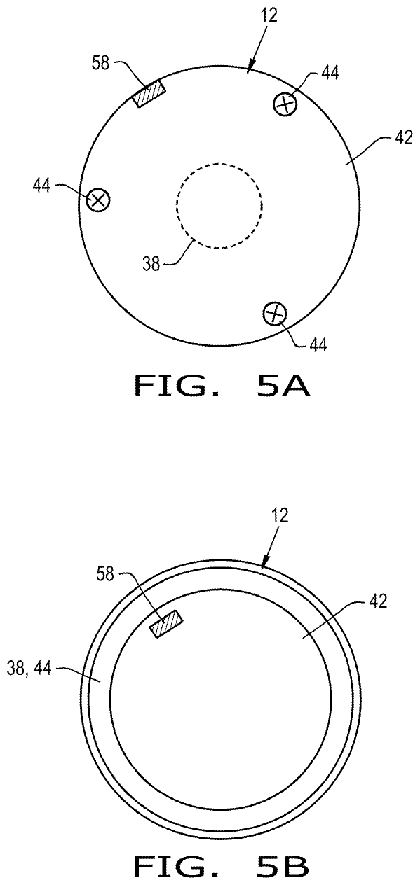

The growth lines 10 and growth plates 12 are configured to enable the growth plates 12 to be releasably secured to the growth lines 10. As nonlimiting examples, the growth lines 10 or at least portions thereof are formed of or contain a magnetic material or a ferromagnetic material and the growth plates 12 or at least portions thereof are formed of or contain a magnetic material or a ferromagnetic material so that the growth plates 12 can be magnetically releasably secured to the growth lines 10. In a preferred but nonlimiting embodiment depicted in FIG. 4, the growth lines 10 are formed of a non-ferromagnetic belt, strap, webbing, cable, etc., that is equipped with magnets 37 spaced apart along its length, and the growth plates 12 are equipped with a coupler 38 formed of or containing a magnet or a ferromagnetic material (e.g., a steel or iron plate or the like) so that the growth plates 12 can be magnetically and releasably secured to a growth line 10 at pre-defined fixation locations defined by the magnets 37 on the growth line 10. Alternatively, the growth lines 10 or portions thereof may be formed of a ferromagnetic material (e.g., a steel cable or plates, respectively) and the couplers 38 of the growth plates 12 may be magnets so that the growth plates 12 can be magnetically and releasably secured to a growth line 10 at any location along a length of the growth line 10. As also represented in FIG. 4, the couplers 38 of the growth plates 12 are adapted to be releasably secured to a complementary coupler 34 of a base 30 secured with an anchor 33 to the seabed 14 where a coral reef is to be constructed, and the growth plates 12 are configured so that coral 36 is capable of growing on surfaces of the plates 12 opposite their couplers 38, as will be discussed in more detail below. Depending on the type of coupler 34 provided on the base 30, the couplers 38 of a growth plate 12 may be centrally located on the plate 12 as represented in FIGS. 4 and 5A, or configured as a ring as represented in FIG. 5B.

FIG. 1 further represents support frames 22 that project upwardly from the seabed 14 and are located so as to allow the growth lines 10 to be suspended between and/or along two or more of the support frames 22 so that the growth plates 12 are suspended a distance above the seabed 14 yet sufficiently close to the seabed 14 to ensure that the environment of the coral on the growth plates 12 is similar to the environment at the seabed 14. The support frames 22 are securely anchored to the seabed 14 prior to deploying the growth lines 10, for example, by being drilled, inserted, or bonded into or onto the seabed 14 or structures placed on the seabed 14. FIG. 1 represents a process of deploying the growth lines 10 laden with the growth plates 12, in which one end of each growth line 10 is secured to a first (leftmost in FIG. 1) support frame 22 but not yet secured to a second (rightmost in FIG. 1) support frame 22. The ROV 20, which may be controlled from the vessel 18 by a tether as represented, may be used to attach the growth lines 10 to the support frames 22.

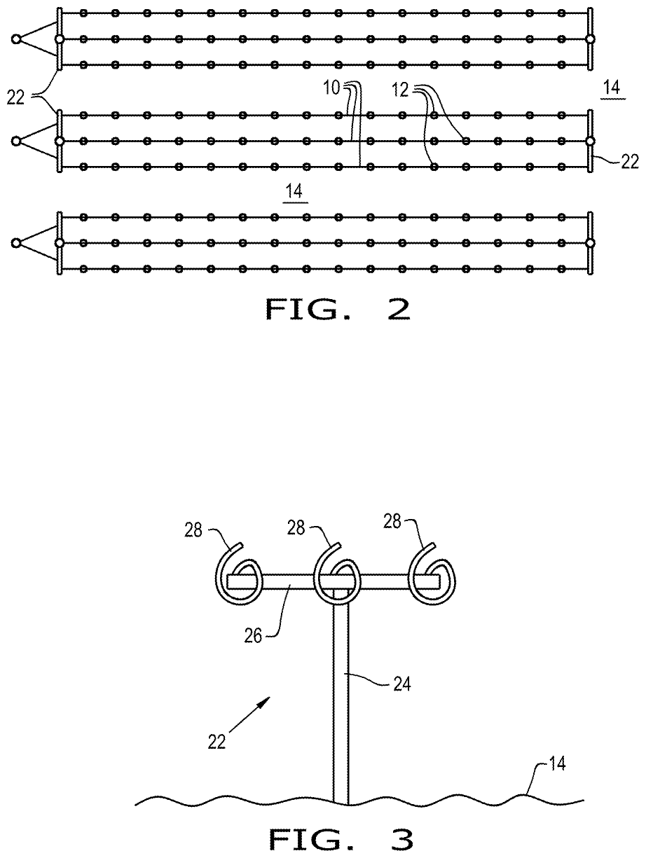

FIG. 2 represents growth lines 10 fully deployed and supported by the support frames 22 above the seabed 14. In this nonlimiting example, three sets of multiple suspended growth lines 10 extend between and are supported by six support frames 22, though it is foreseeable that fewer or more growth lines 10 could be supported by fewer or more support frames 22, including support frames 22 positioned along the length of a growth line 10 between its two support frames 22 shown. A segment of each growth line 10 between a pair of support frames 22 is preferably sufficiently tensioned such that the growth line 10 does not sag onto the seabed 14 or otherwise allow the growth plates 12 attached thereto to touch the seabed 14. This may be accomplished, for example, by means of loops, hooks, or perforations disposed at intervals along the growth lines 10 near where they are to be connected to the support frames 22, thereby enabling the ROV 20 to be used to couple the growth lines 10 to the support frames 22 and adjust the length of a growth line 10 extending between two support frames 22. Alternatively, or in addition, a tensioning rachet and a captive shackle can be utilized to maintain tension in a growth line 10.

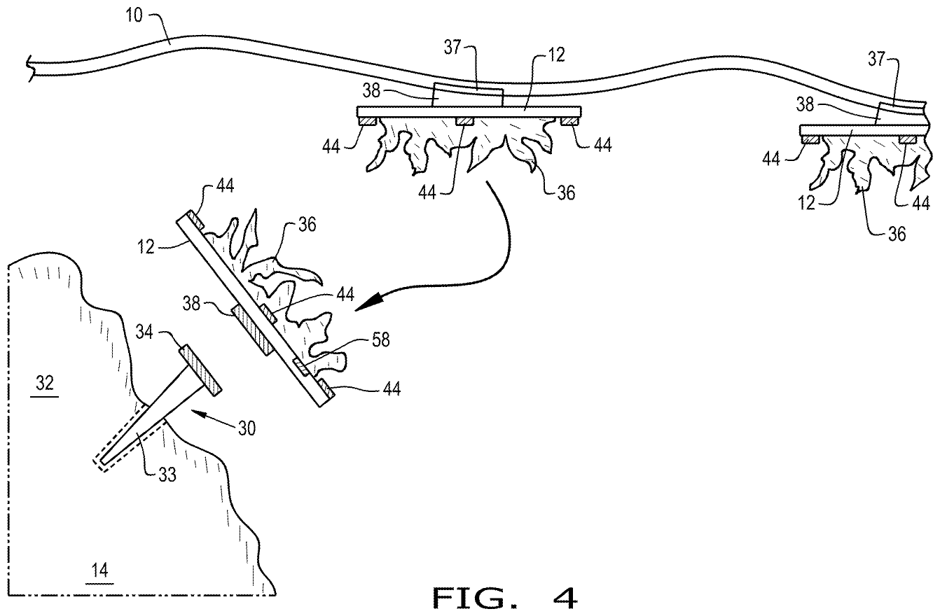

FIG. 3 represents one of the support frames 22 as it might appear oriented to extend vertically upward from the seabed 14 in an installed position. The particular but nonlimiting embodiment of the support frame 22 represented in FIG. 3 is generally T-shaped, with the lower end of a column 24 inserted into and extending upward from the seabed 14, and a cross beam 26 disposed at the top of the column 24 and oriented transverse to the column 24. Couplers 28 for coupling the growth lines 10 to the support frame 22 are disposed on and spaced apart along the cross beam 26. Each coupler 28 is configured to capture a growth line 10 and secure it to the support frame 22. In this example, the couplers 28 are each represented as a coiled hook member with a distal free end pointing upwardly and coiling therefrom downwardly below and then around the cross beam 26. However, other shapes and configurations are possible. Depending on particular conditions, currents, etc., present at the seabed 14, the support frame 22 may comprise additional structural features to help support and stabilize the column 24 in an upright orientation and maintain a desired level of tension of the growth line 10. As nonlimiting examples, the support frame 22 may include supplemental structures such as one or more augers if the seabed 14 is formed by sand or other loose sediment, or one or more rock pitons in areas of a seabed 14 where there is bedrock and little sand coverage.

FIG. 4 schematically represents a growth plate 12 being transferred from a growth line 10 to the base 30, which as described above is anchored in the seabed 14 so that the coral 36 growing on the plate 12 is effectively transplanted to a location on the seabed 14 where a coral reef is to be constructed. The base serves as a mount for the growth plate 12 and is capable of being inserted into and secured to a suitable substrate on or within the seabed 14, such as coral bedrock 32. The anchor 33 of the base 30 may be in the form of a ground spike or piton that is embedded into or bonded to the coral bedrock 32, such as by piercing or drilling into the bedrock 32, optionally with the assistance of a pneumatic or hydraulic impact tool or the like.

As previously noted, the base 30 includes a coupler 34 configured to couple to the coupler 38 of a growth plate 12 with which the plate 12 is releasably secured to the growth line 10. The coupler 34 of the base 30 is located at a distal end of the base 30 that is exposed above the coral bedrock 32 when the base 30 is anchored in the seabed 14, such that the growth plate 12 and coral 36 growing thereon are exposed at or above the seabed 14. The coupler 38 of the growth plate 12 determines the type of coupler 34 most suitable for the base 30. For example, if the growth plate coupler 38 is a magnet, then the coupler 34 of the base 30 may be a magnet or may be a formed of a ferromagnetic material. In embodiments in which the coupler 38 of the growth plate 12 is not a magnet, for example, formed of a ferromagnetic material, then the coupler 34 of the base 30 may be a magnet for magnetically securing the coupler 38, or may be a clip, socket, etc., configured to mechanically capture the coupler 38. Alternatively, the coupler 38 of the growth plate 12 represented in FIG. 5B is configured as a ring that, depending on whether or not the ring is formed of a ferromagnetic material, can enable an appropriately-configured coupler 34 of a base 30 to magnetically or mechanically capture the ring-shaped coupler 38. In embodiments in which the use of magnets in the system is desired to be minimized, the couplers 34 and 38 are preferably other than magnets, for example, the coupler 38 of the growth plate 12 may be formed of a ferromagnetic material (enabling the growth plate 12 to be magnetically coupled to a magnet 37 on the growth line 10 as described above), and the coupler 34 of the base 30 is a clip, socket, etc., that is configured to mechanically capture the coupler 38.

As previously noted, the system described above allows coral 36 to be grown from spores or fragments on the growth plates 12 while the plates 12 are located within the protective environment of a nursery, and once the coral is deemed capable of surviving outside the nursery the growth plates 12 are transported to and placed in a seabed nursery area. Instead of immediately transplanting the coral 36 growing on the growth plats 12 to the seabed 14, the growth lines 10 and support frames 22 are utilized to suspend the growth plates 12 within the seabed nursery area to allow for the continued growth of the coral 36 in its future habitat with matching conditions within the area of the seabed 14 where the coral 36 will be transplanted. Once growth is verified and sustained, the growth plates 12 are removed from the growth line 10 and then transferred and coupled to the bases 30 on the seabed 14. Once installed on a base 30, the desire is for the coral 36 to continue to grow and eventually cover the entire area, including the coral bed rock 32 around the base 30.

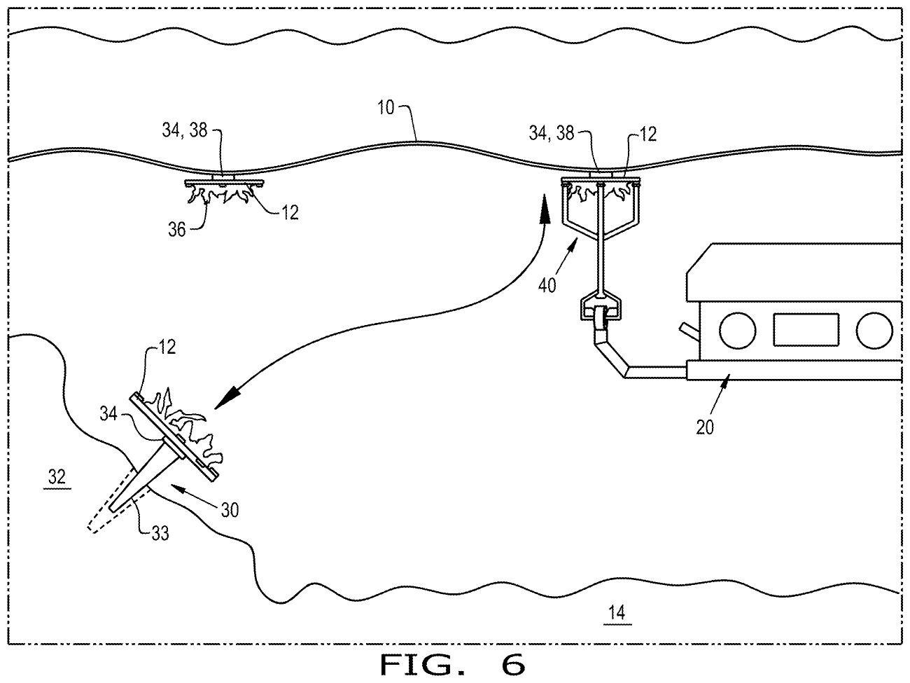

FIG. 6 represents the use of the ROV 20 to remove a growth plate 12 from the growth line 10 for the purpose of transferring and coupling the growth plate 12 to a base 30 on the seabed 14. The ROV 20 is represented as equipped with tooling 40 that is configured to be manipulated by the ROV 20, such as at the end of a robotic arm, and coupled to growth plates 12 disposed on the growth line 10. The ROV 20 is preferably, though not necessarily, configured to magnetically couple the tooling 40 to the growth plate 12. The ROV 20 then removes each growth plate 12 from the growth line 10 with the tooling 40 and moves it toward the base 30, where the ROV 20 can be used to manipulate the tooling 40 to couple the coupler 38 on the growth plate 12 to the coupler 34 on the base 30. It should be noted that this process of using the tooling 40 could also be manually performed, such as by a diver. After the growth plates 12 have been transferred from the growth lines 10 to the bases 30, the growth lines 10 can be recovered from the seabed 14, for example, by being spooled onto the reel 16 on the vessel 18 with the assistance of the ROV 20 and be readied to restart the process.

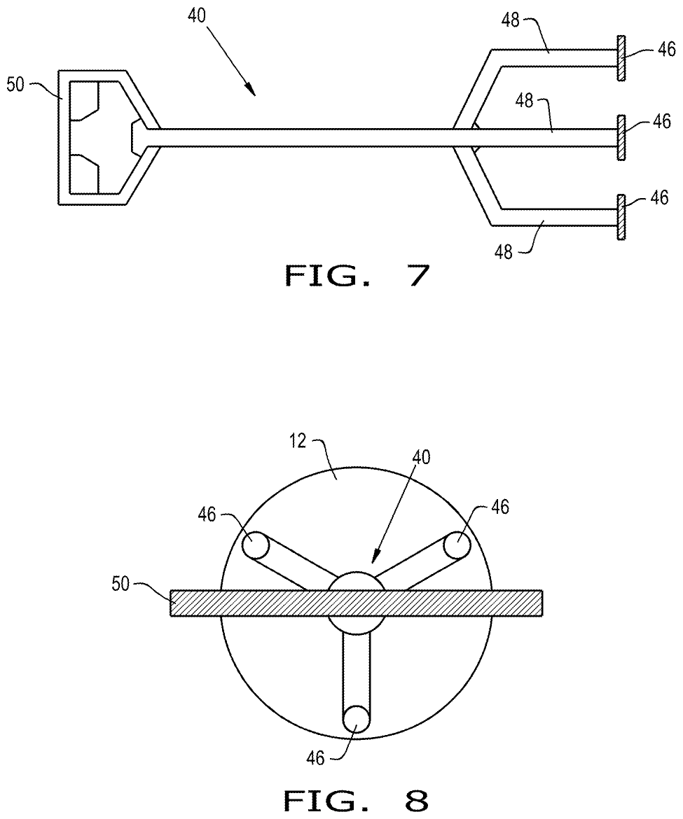

As depicted in FIGS. 5A and 5B, the growth plates 12 are generally configured as a disc 42, which may be formed of a ceramic material or other material that can withstand a seabed environment. As previously noted, FIG. 5A depicts the coupler 38 disposed centrally on one side of the disc 42. Additionally, three couplers 44, for example, magnets, clips, etc., are disposed on the opposite side of the disc 42 angularly spaced apart adjacent an outer peripheral edge of the disc 42. As represented in FIGS. 7 and 8, the tooling 40 may include three grips 46 disposed at respective ends of three tines 48 that are configured to align with the couplers 44 on the growth plate 12 of FIG. 5A. The tooling 40 can be similarly utilized to manipulate a growth plate 12 of a type represented in FIG. 5B by engaging its three grips 46 with a single ring-shaped coupler 44 on the plate 12, which may be a separate element of the plate 12 or a ring that serves as both couplers 38 and 44.

In a preferred but nonlimiting embodiment, the couplers 44 on the growth plate 12 of FIG. 5A are formed of a ferromagnetic material and the grips 46 of the tooling 40 are adapted to magnetically attach to the couplers 44. The tooling 40 has a handle 50 that is configured to be gripped by a robotic arm of the ROV 20, by a diver, etc. The handle 50 is disposed at an end of the tooling 40 opposite the grips 46. When it is desired to transfer a growth plate 12 from a growth line 10 to a base 30, the grips 46 on the tooling 40 are aligned with and then coupled to the couplers 44 on the growth plate 12, thereby coupling the growth plate 12 to the tooling 40. The tooling 40 can then be used to remove the growth plate 12 from the growth line 10, move the growth plate 12 toward the seabed 14, and then secure the growth plate 12 to the base 30 by coupling its coupler 38 to the coupler 34 of the base 30.

FIGS. 5A and 5B depict their respective growth plates 12 as being further equipped with a data marker 58 for providing data about the coral and/or other features related to the growth plate 12. As nonlimiting examples, the data marker 58 can provide data related to the reef type, dates, plantation, and growth to aid in scientific research by recording ambient environmental conditions. The data marker 58 may comprise, for example, a radio frequency identification (RFID) data tag that can be read by data reading equipment on the ROV 20, or carried by a diver, or onboard the vessel 18. Other types of data devices could be used. In preferred embodiments, readings from the data marker 58 can be used to trigger sensors on the ROV 20 to gather ambient environmental conditions, take photographs, perform scans, and/or take laser measurements of the coral growth for acquisition into a database for scientific research and historic trends. During latter growth stages of the coral, color, and visual sensors on the ROV 20 may be used to identify evasive species, for example, by means of machine learning, to control populations and aid bio-diversity.

As previously noted above, though the foregoing detailed description describes certain aspects of one or more particular embodiments of the invention, alternatives could be adopted by one skilled in the art. For example, the coral reef construction system and its devices could differ in appearance and construction from the embodiments described herein and shown in the drawings, functions of certain components of the system and devices could be performed by components of different construction but capable of a similar (though not necessarily equivalent) function, and various materials could be used in the fabrication of the system and/or its devices. As such, and again as was previously noted, it should be understood that the invention is not necessarily limited to any particular embodiment described herein or illustrated in the drawings.

1. A system for constructing a coral reef, the system comprising:
at least a first growth line having first couplers attached thereto;
support frames supporting the first growth line above a seabed;
growth plates releasably coupled to the first growth line and supported thereby above the seabed, each of the growth plates having first and second surfaces, a second coupler at the first surface thereof that is configured for releasably coupling to one of the first couplers of the first growth line, and a third coupler at the second surface thereof, the second surfaces of the growth plates being operable for growing coral thereon; and
bases each having an anchor configured for securing the base to the seabed and having a fourth coupler configured for releasably coupling to the second couplers of the growth plates.

2. The system of claim 1, wherein at least some of the first and second couplers magnetically couple the growth plates to the first growth line.

3. The system of claim 2, wherein the second couplers are centrally located on the growth plates.

4. The system of claim 1, wherein at least some of the second and fourth couplers magnetically couple the growth plates to the bases.

5. The system of claim 1, wherein at least some of the second and fourth couplers mechanically couple the growth plates to the bases.

6. The system of claim 1, further comprising tooling for transferring the growth plates to the bases, the tooling comprising a fifth coupler configured for releasably coupling to the third couplers of the growth plates.

7. The system of claim 6, wherein the third couplers are located adjacent perimeters of the second surfaces of the growth plates.

8. The system of claim 6, further comprising a remote-operated vehicle operable for manipulating the tooling to engage the fifth coupler thereof with the third couplers of the growth plates, transfer the growth plates to the bases and couple the second couplers of the growth plates with the fourth couplers the bases, and then release the fifth coupler of the tooling from the third couplers of the growth plates.

9. The system of claim 8, wherein at least some of the third and fifth couplers magnetically couple the growth plates to the tooling.

10. The system of claim 1, further comprising a remote-operated vehicle operable for releasably attaching the first growth line to the support frames.

11. The system of claim 1, further comprising a data marker attached to at least one of the growth plates, the data marker being operable to capture metadata relating to the seabed and/or the growth plate to which the data marker is attached.

12. The system of claim 11, wherein the metadata comprises at least one of reef type, dates, plantation, and growth of the coral on the second surface of the growth plate to which the data marker is attached.

13. The system of claim 11, wherein the data marker comprises a radio frequency identification data tag.

14. The system of claim 11, further comprising a remote-operated vehicle operable for reading the metadata of the data marker.

15. The system of claim 14, wherein the data marker is operable to trigger the remote-operated vehicle to perform at least one of gathering ambient environmental conditions, taking photographs, performing scans, and taking laser measurements of the coral growth.

16. The system of claim 14, wherein the remote-operated vehicle is operable to identify evasive species.

17. The system of claim 1, further comprising a vessel and a reel disposed on the vessel operable to dispense the first growth line from the reel to the support frames while the support frames are secured to the seabed.

18. An artificially-constructed coral reef comprising the system of claim 1, wherein coral is on the second surfaces of the growth plates while the growth plates are releasably coupled to the first growth line and the first growth line is suspended by the support frames above the seabed.

19. A method of using the system of claim 1 to construct a coral reef, the method comprising:
growing coral on the second surfaces of the growth plates;
coupling the second couplers of the growth plates to the first couplers of the first growth line;
deploying the first growth line with the growth plates coupled thereto from a vessel to support the first growth line and the growth plates coupled thereto above the seabed within a seabed nursery area;
further growing the coral on the growth plates;
decoupling the growth plates from the first growth line; and then
transferring the growth plates to the bases after the bases have been secured to the seabed with the anchors thereof so as to construct a coral reef.

20. The method of claim 19, wherein the coral is grown from spores or fragments on the growth plates while the growth plates are located within a protective environment of a nursery, and the growth plates are transported to and placed in the seabed nursery area once the coral is capable of surviving outside the nursery.
